(19) United States
(12) Patent Application Publication
(10) Pub. No.: US 2004/0130745 A1
(43) Pub. Date: Jul. 8, 2004

(54) Automatic printer optimization settings

(75) Inventors: Josh L. Fabel, Boca Raton, FL (US); Glen A. Auchter, Parkland, FL (US); Gene I. Kofman, Parkland, FL (US); Warren M. Fabel, Boca Raton, FL (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: Laser Substrates, Inc., Boca Raton, FL

(21) Appl. No.: 10/360,298

(22) Filed: Feb. 7, 2003

Related U.S. Application Data
(60) Provisional application No. 60/437,893, filed on Jan. 3, 2003.

(51) Int. Cl. G06F 15/00; G06F 3/12

(52) U.S. Cl. 358/1.15; 358/1.13

(57) ABSTRACT

A system, method and computer readable medium for automatically setting optimal printer settings is disclosed. The method on a computer system includes defining a first printer setting group for a first type of print job and storing in a configuration file the first printer setting group for the first type of print job. The method further includes receiving a print command for a print job and searching the configuration file for a printer setting group corresponding to the print job according to the type of the print job. The method further includes identifying the first printer setting group as corresponding to the print job and reading from the configuration file the first printer setting group for the first type of print job. The method further includes sending the first printer setting group to a printer and sending the print job of the print command to the printer.

### CROSS-REFERENCED APPLICATIONS

The present non-provisional application claims priority to the provisional patent application serial No. 60/437,893 with inventors Kofman et al., entitled “AUTOMATIC PRINTER OPTIMIZATION SETTINGS” filed Jan. 3, 2003, which is hereby incorporated by reference in its entirety.

The subject matter of the present application is related to the following commonly owned U.S. Patents: U.S. Pat. No. 5,865,717, filed Jun. 7, 1995, issued Feb. 2, 1999 to Fabel for a Mailing Form for Non-impact Printing, U.S. Pat. No. 6,095,919, filed Oct. 27, 1998, issued Aug. 1, 2000 to Fabel for an Extendible Form for Non-Impact Printer and U.S. Pat. No. 6,173,888, filed Feb. 2, 1999, issued Jan. 16, 2001 to Fabel for a Mailing Form for Non-Impact Printing. Each U.S. Patent described above is hereby incorporated by reference in its entirety.

The subject matter of the present application is further related to the following commonly owned U.S. Applications: non-provisional patent application serial No. 10/272,161 with inventors Kofman et al., entitled “DATA CAPTURE DURING PRINT PROCESS” filed Oct. 15, 2002, which is hereby incorporated by reference in its entirety. The aforementioned non-provisional application is a continuation in part of the non-provisional patent application serial No. 10/172,154 with inventors Kofman et al., entitled “PRINTING IN A SECURE ENVIRONMENT” filed Jun. 14, 2002, which is hereby incorporated by reference in its entirety. The aforementioned non-provisional application is a continuation in part of the non-provisional patent application serial No. 10/133,100 with inventors Kofman et al., entitled “MAPPING A PRINT STREAM FOR PRINTING ON MAILERS FROM A FIRST APPLICATION FOR INPUT TO A SECOND APPLICATION” filed Apr. 26, 2002, which is hereby incorporated by reference in its entirety. The aforementioned non-provisional application is based on the provisional patent application serial No. 60/367,118 with inventors Kofman et al., entitled “MAPPING A PRINTER STREAM FOR PRINTING ON POSTAL FORMS” filed Mar. 22, 2002, which is hereby incorporated by reference in its entirety.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever. BACKGROUND OF THE INVENTION

1. Field of the Invention

This invention generally relates to the field of computer printers and more specifically to optimal settings for computer printers.

2. Description of Related Art

As technology progresses, the business office is becoming more and more automated. Faxes, file servers, email, teleconferencing and cell phones have revolutionized the way firms do business. Mailers, in particular, have enjoyed increasing popularity. A mailer is a consumable paper product that allows for quick and easy printing and mailing of information. A mailer can include an envelope, an insert and a return envelope, which may be created by folding the original document. For example, mailers are used to send account statements, invoices, checks, and tax forms to customers and employees of a business. The commonly owned U.S. Patents and U.S. Application described above provide more information on mailers.

A mailer allows a firm or small business to print directly onto one product all of the information necessary for mailing to a customer, client or employee. This is advantageous as it eliminates the separate printing of an envelope, an insert and a return envelope, as well as the need for the insertion of the return envelope and the insert into the envelope. Other consumables include paper of any size and type, such as, photographic paper, labels such as those produced by Avery®, envelopes, postcards and other items used with non-impact printers.

Labels have also enjoyed increasing popularity. Labels are often used to merge address data from an address book or other address repository onto mailing labels for sending out mass mailings. This automates and expedites the process of printing out large amounts of mailing labels for a mass mailing. For example, mailing labels can be used for mass mailing holiday cards or notices to customers and employees of a business. This is advantageous as it eliminates the separate printing of each mailing label when the printing of large amounts of mailing labels is required.

When non-impact printers were originally introduced, the developers intended to print on 20 lb. paper, or equivalent only. Even perforations were not recommended. The printing process has matured to the degree that non-impact printers are now required to process various substrates, which include papers from 10 lb basis to heavy card stock and even plastics and laminations with silicon and glue. The use of non-impact printers, however, do not come without their drawbacks.

The semi-conductor silicon, for example, which is used as a common media for pressure sensitive products and substrates often create problems on xerographic non-impact printers that are dependent on uniform heating to fuse toner. Further, printing quality is reduced through the increased use of recycled printing paper, which tends to contain oils and contaminants from previous usage. In addition, greater usage of refilled toner cartridges, which are not specifically tailored to the particular printer, create new problems in that the fusion temperature window of the toner may not specifically match that of the printer. Moreover, printer manufacturers are becoming more dependent on the consumable segment of the market as major profit centers. To increase usage they set printer defaults to the least efficient settings, which are not necessarily the optimum settings for print quality on a particular substrate.

In addition to the drawbacks of using non-impact printers, the adjustment of printer settings can be confusing and time-consuming. For example, barcodes and special fonts, such as the E13B font for Magnetic Ink Character Recognition (MICR) encoding, have become widely used with non-impact printers. Requirements for quality printing with these fonts vary according to the type of print outs and correspondence and the paper used. Further, many printer defaults are available only through the control panel of the printer. Correctly setting these defaults is often beyond the capabilities of the typical computer user. Additionally, this process is cumbersome and may not be feasible in a shared environment where a printer is utilized by many users. Another problem that occurs is providing settings for optimum performance of a print job, and then not returning to standard defaults before the printer is required to print another project, with entirely different requirements and parameters.

Therefore, a need exists to overcome the problems with the prior art as discussed above and particularly for an efficient way to set optimal printer settings when printing.

### SUMMARY OF THE INVENTION

Briefly, in accordance with the present invention, disclosed is a system, method and computer readable medium for automatically setting optimal printer settings. In an embodiment of the present invention, the method on a computer system includes defining a first printer setting group for a first type of print job and storing in a configuration file the first printer setting group for the first type of print job. The method further includes receiving a print command for a print job and searching the configuration file for a printer setting group corresponding to the print job according to the type of the print job. The method further includes identifying the first printer setting group as corresponding to the print job and reading from the configuration file the first printer setting group for the first type of print job. The method further includes sending the first printer setting group to a printer and sending the print job of the print command to the printer.

In an embodiment of the present invention, the method further includes reading, before sending the print job to the printer, current printer settings and storing the current printer settings. The method further includes sending the current printer settings that were stored to the printer after printing.

The described embodiments of the present invention are advantageous as they allow for the automation of setting optimal printer settings. This allows for great efficiency in printing and eliminates wastes by decreasing the amount of paper and toner consumed. Another advantage of the present invention is that the method of the present invention is transparent to the user. Once the optimal printer settings are defined, the user simply prints a document and little or no interaction is needed with the proposed system. This results in increased usability of the printing system. Yet another advantage of the present invention is the lack of persistence of optimal printer settings. The present invention sets optimal printer settings for a particular print job and immediately returns the printer to its original settings. This is beneficial as it facilitates the use of the printer by different users on a network who desire to print different print jobs with different printer settings.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2 is a functional diagram illustrating the optimal printer setting definition process according to one embodiment of the present invention.

FIG. 3A is a flowchart depicting the operation and control flow of the overall process of one embodiment of the present invention.

FIG. 3B is a flowchart depicting optional steps of the operation and control flow of the process of FIG. 3A.

FIG. 4 is a functional diagram illustrating the operation and control flow of the overall process of one embodiment of the present invention.

FIG. 5 is a block diagram of a computer system useful for implementing the present invention.

FIG. 6 is an illustration of an example printer with a control panel and trays.

### DETAILED DESCRIPTION OF THE PREFERRED EMBODIMENTS

### I. Overview

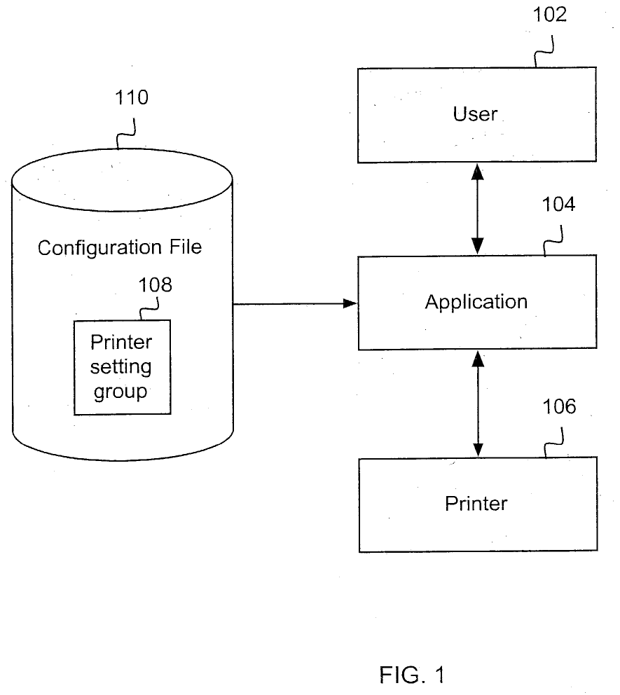

FIG. 1 is a block diagram illustrating the overall system architecture of one embodiment of the present invention. A user 102 utilizes a client computer system or information processing system to execute an application 104. The printer setting group 108 represents a group of printer settings that are optimal for a particular print job. This is described in greater detail below. The printer setting group 108 is stored in a configuration file 110. The application 104 performs the automatic printer setting adjustment operation of the present invention, i.e., determining which printer setting group in configuration file 110 to utilize, selecting the correct printer setting group in configuration file 110 and sending the printer setting group and the print job to the printer 106. In an embodiment of the present invention, the application 104 executes on the same computer system as the client computer system of user 102. In another embodiment of the present invention, the application 104 executes on a different computer system as the client computer system of user 102 and the two computer systems are connected via a network. An example network is described below.

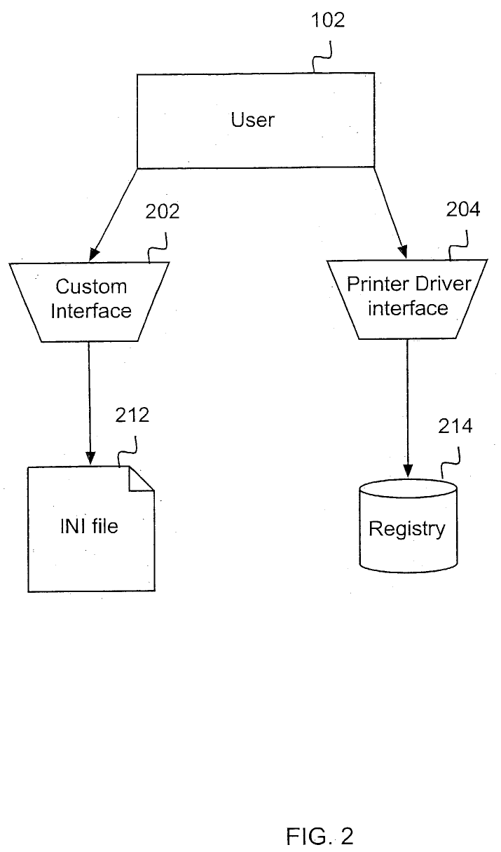

The configuration file 110 is a repository for storing mo*re than one printer setting group 108. In an embodiment, the configuration file 110 is a plain file that lists printer setting information in text or other format. In another embodiment, the configuration file 110 is a commercial database for storing relational or object oriented data and wherein printer setting groups are stored as separate entities. In yet another embodiment, the configuration file 110 is a file, table or other structure located on a remote computer and provided to the application 104. In this embodiment, the remote computer housing the configuration file 110 is connected to the computer of application 104 through a network such as the Internet. Additional examples of a configuration file 110 are described below with reference to FIG. 2. Note that although only one printer setting group 108 is shown in configuration file 110, the configuration file 110 supports the storage of any number of printer setting groups 108.

The computer systems of the user 102 and application 104 comprise one or more Personal Computers (PCs) (e.g., IBM or compatible PC workstations running the Microsoft Windows 95/98/2000/ME/CE/NT/XP operating system, Macintosh computers running the Mac OS operating system, PCs running the LINUX operating system or equivalent), Personal Digital Assistants (PDAs), game consoles or any other computer processing devices. In another embodiment of the present invention, the computer systems of the user 102 and application 104 are one or more server systems (e.g., SUN Ultra workstations running the SunOS or AIX operating system, IBM RS/6000 workstations and servers running the AIX operating system or servers running the LINUX operating system).

The application 104 is any application that routinely sends information to a printer 106, such as a word processor, a spreadsheet program, a financial software program, a presentation program or a graphic art design application. The printer 106 is a commercially available printer, such as a non-impact printer, a laser printer, an inkjet printer, a bubble jet printer, a dot matrix printer, a thermal printer, or the like. Examples of printer 106 are Hewlett Packard printers, Lexmark printers, Xerox printers, Canon printers, Dell Printers, Okidata printers and IBM printers.

In an alternate embodiment of the present invention, FIG. 1 includes a network (not shown) situated between application 104 and user 102, and/or between application 104 and printer 106 and/or between application 104 and configuration file 110. The network is a circuit switched network, such as the Public Service Telephone Network (PSTN). In another embodiment of the present invention, the network is a packet switched network. The packet switched network is a wide area network (WAN), such as the global Internet, a private WAN, a local area network (LAN), a telecommunications network or any combination of the above-mentioned networks. The network is a wired network, a wireless network, a broadcast network or a point-to-point network.

As explained above, the printer setting group 108 represents a group of printer settings that are optimal for a particular print job. A print job consists of a set of information that is utilized to determine the appropriate printer setting group that corresponds to that print job. The set of information in a print job that is utilized to make this determination includes at least one of: 1) a document type, 2) a printer type, 3) the toner cartridge type in the printer, 4) the media type such as a substrate (as described in the background section) and/or a consumable, upon which the document will be printed and 5) the age of the printer.

A document type affects optimal printer settings because certain document types require different printer settings. For example, a resume printed on high-quality paper requires more resolution than an office fax printed on standard stock paper. Printer type affects optimal printer settings because printers vary as to ability and quality. For example, certain printers require more toner to achieve the same definition as other printers with a lower toner setting. Toner cartridge type affects optimal printer settings because recycled toner cartridges often do not allow for printing of the same quality including fusing at the same temperature as new, name brand toner cartridges. Thus, a recycled toner cartridge sometimes requires adjustment of printer settings to achieve the same quality as a printer having a new, name brand toner cartridge.

Media type affects optimal printer settings because different paper or media require different ink and/or toner settings. For example, the printer settings for printing on paper having high cotton content is different from the printer settings for printing on standard stock paper. Lastly, printer age affects optimal printer settings because age can affect the manner in which a printer is able to fuse toner onto paper. Often, older printers require a higher toner setting to achieve the same definition as other printers with a lower toner setting.

Thus, each print job is associated with a particular optimal printer setting group 108. This is because the set of information described above for a print job lends itself to a particular printer setting group 108 that is optimal. The printer settings of a printer setting group 108 include at least one of:

print speed

toner density

heat setting (fuser temperature)

print resolution

toner setting

paper tray identifier

print quality

color

saturation

contrast

brightness

dithering

gray scale

paper size

orientation

margins

fonts

printable area

manual feed

resolution enhanced technology (RET)

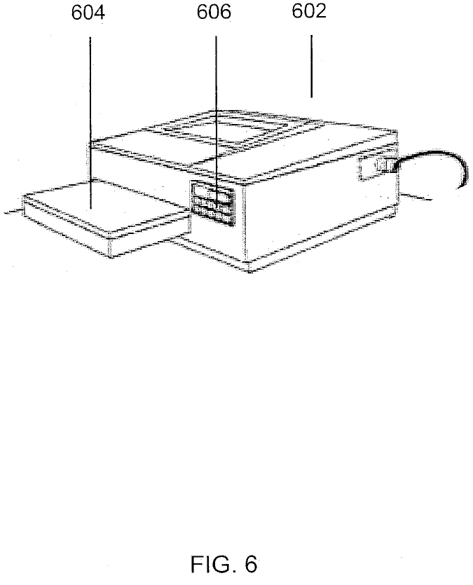

Those printer settings of a printer setting group 108 that are not available for adjustment through a print dialog or GUI but that are available through the physical control panel of a printer include print speed, toner density and heat setting (fuser temperature). This is described in greater detail below with reference to FIG. 6.

### II. Automatic Setting of Optimal Printer Settings

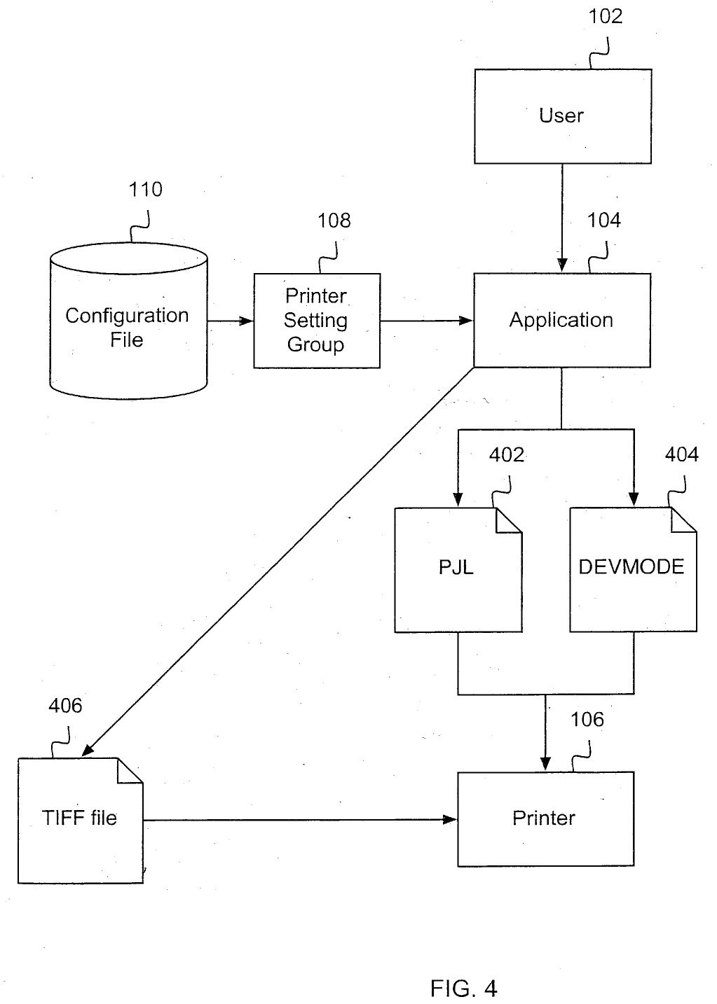

FIG. 2 is a functional diagram illustrating the optimal printer setting definition process according to one embodiment of the present invention. FIG. 2 shows one embodiment of the process of defining the optimal printer setting group 108 for a particular print job. FIG. 2 depicts in more detail the printer setting definition process of steps 404 and 406 of FIG. 4 described below.

FIG. 2 shows examples of a configuration file 110 for storing optimal printer setting group 108—a registry 214 and an INI file 212. The registry 214 is a Microsoft Windows structure and corresponding interface that is used to house configuration data for the operating system and for individual applications executing in the operating system. The registry 214 can thus be used to store the optimal printer setting group 108 for a particular print job.

In one embodiment, the optimal printer setting group 108 is stored in the registry 214 in a DEVMODE format. A DEVMODE structure is a Microsoft Windows data format used for specifying characteristics of display and print devices. Specifically, the DEVMODE data structure contains information about the initialization and environment of a printer or a display device. A DEVMODE structure is typically stored in the RAM allocation of the operating system. Examples of device characteristics that may be specified in a DEVMODE format include: the device name, the version number of the device driver of the device, the orientation of the paper on which a document will be printed, the number of copies of a document for printing, etc.

The INI file 212 represents any Microsoft Windows operating system file that is used to house configuration data for applications executing in the operating system. An INI file is typically a text file with an “INI” extension in the file name. The INI file 212 can thus be used to store the optimal printer setting group 108 for a particular print job. In one embodiment, the optimal printer setting group 108 is stored in the INI file 212 in a custom format. In another embodiment, the optimal printer setting group 108 is stored in the INI file 212 in a DEVMODE format, a PJL or PCL format (PJL is described in greater detail below) or any other format capable of defining printer settings.

FIG. 2 also shows a custom interface 202 and a printer driver interface 204. The custom interface 202 is used to interface with the INI file 212 so as to allow the user 102 or the application 104 to modify printer setting group 108 stored in the INI file 212. The custom interface 202 is a graphical user interface, a command line interface or any other interface capable of allowing a user or application to modify printer settings. The printer driver interface 204 is used to interface with the registry 214 so as to allow the user 102 or the application 104 to modify printer settings stored in the registry 214. The printer driver interface 204 is a graphical user interface, a command line interface or any other interface capable of allowing a user or application to modify printer settings.

Although FIG. 2 shows a user 102 interfacing with the INI file 212 or the registry 214 via the custom interface 202 or the printer driver interface 204, respectively, in another embodiment of the present invention, the application 104 or any other application can interface with the INI file 212 or the registry 214 via the custom interface 202, the printer driver interface 204 or any other interface so as to allow the modification of printer settings stored in the INI file 212 or the registry 214. Note also that although FIG. 2 shows that optimal printer setting group 108 is defined using a custom interface 202 or a printer driver interface 204 and stored either in an INI file 212 or a registry 214, respectively, this is shown only by way of example. The present invention supports the definition of optimal printer setting group 108 using any interface allowing for such and supports the storage of optimal printer setting group 108 in any location and in any format on the computer of user 102 or a remote server for printing.

A knowledgeable user 102 can create an optimal printer setting group 108 for a particular print job by trial and error and/or experimentation. Once an acceptable optimal printer setting group 108 is identified, it can be stored for future use in the configuration file 110. Alternatively, an optimal printer setting group 108 for a particular print job can be garnered from another source, such as from another use or from a web site or other remote source.

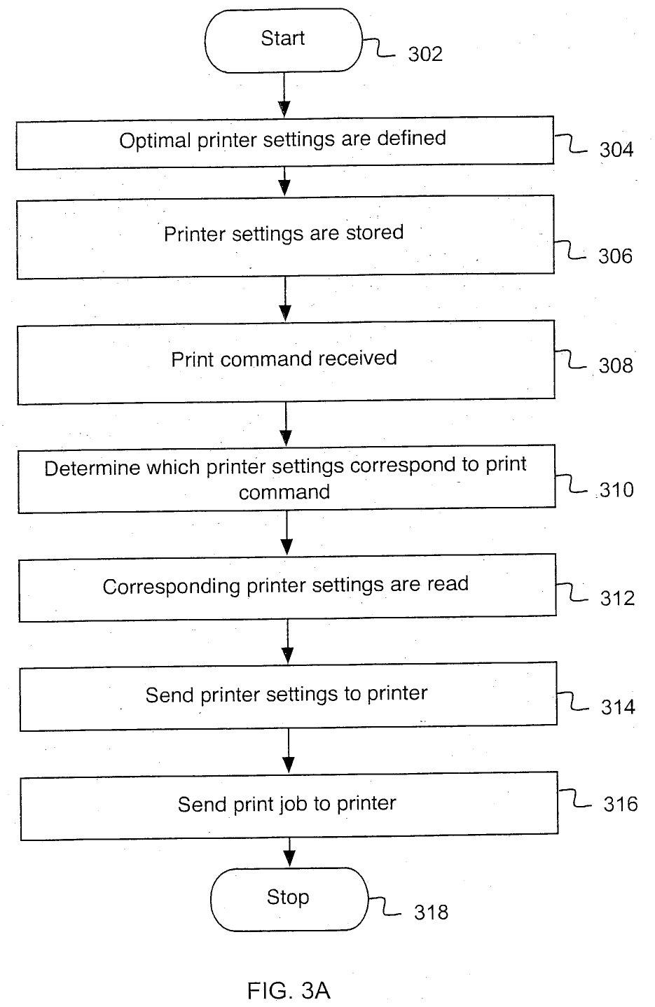

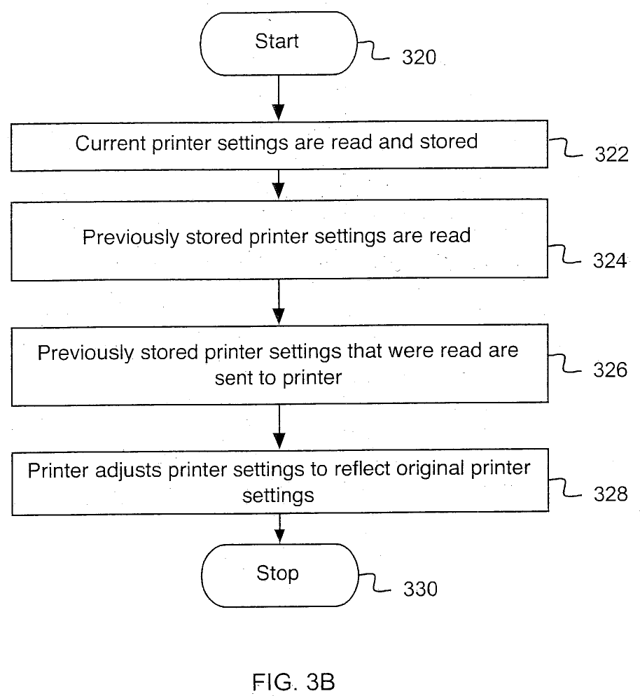

FIG. 3A is a flowchart depicting the operation and control flow of the overall process of one embodiment of the present invention. The control flow of FIG. 3A begins with step 302 and flows directly to step 304. In step 304, an optimal printer setting group 108 for a first print job is defined. As noted above, the optimal printer settings for a particular print job depend on a variety of information. Thus, each unique print job is associated with a particular optimal printer setting group 108. In step 304, the optimal printer setting group 108 for a first print job is defined using, for example, a custom interface 202 or a printer driver interface 204. More detail regarding the process of step 304 is provided above with reference to FIG. 2.

In step 306, the optimal printer setting group 108 defined in step 304 is stored in a configuration file 110. For example, the optimal printer setting group 108 is stored either in an INI file 212 or a registry 214. More detail regarding the process of step 306 is provided above with reference to FIG. 2. Although steps 304 and 306 describe the definition and storage of an optimal printer setting group 108 for one print job, the present invention supports the definition and storage of multiple optimal printer setting groups 108 for multiple print jobs.

In step 308, a print command is received by the application 104. The print command can be received by any application having the capability to print information to a printer 106, including application 104. In step 310, the application 104 determines which of the optimal printer setting groups defined in step 306 correspond to the print job of the print command of step 310. This can be accomplished by prompting the user 102 to specify which of the predefined optimal printer setting groups 108 shall be utilized by the printer 106. Alternatively, this can be accomplished automatically by the application 104 by matching the current print job with one of the predefined optimal printer setting groups 108 (e.g., a print job for plain paper, for printing on labels, etc.).

In step 312, the optimal printer setting group 108 corresponding to the print job of the print command of step 310 is identified. Thus, the identified optimal printer setting group 108 for the print command of step 310 is read from configuration file 110. In step 314, the identified optimal printer setting group 108 for the print command of step 310 is sent to the printer 106. In step 316, the print job for the print command of step 310 is sent to the printer 106. In step 318, the control flow of FIG. 3A stops.

In one embodiment of the present invention, the control flow of FIG. 3A includes the following optional steps represented in FIG. 3B. FIG. 3B is a flowchart depicting optional steps of the operation and control flow of the process of FIG. 3A. The control flow of FIG. 3B begins with step 320 and flows directly to step 322. In a step 322 (executed before step 314 of FIG. 3A), the current printer settings of the printer 106 are read and stored. Subsequently, steps 314-316 of FIG. 3A are executed. Then, in a step after 316 of FIG. 3A, the current printer settings of the printer 106 that were read and stored are subsequently read, in step 324, and sent to the printer 106 for adjustment, in step 326. In step 328, the printer 106 adjusts its printer settings to reflect the previously stored printer settings. In step 330, the control flow of FIG. 3B stops.

This embodiment of the present invention is advantageous as it allows for returning the printer 106 to its original printer setting state after printing. This is beneficial in an environment where different print jobs having different optimal printer setting groups 108 are sent to the printer 106. Returning the printer 106 to its original printer setting state after printing eliminates the lingering of a particular optimal printer setting group 108 after printing.

FIG. 4 is a functional diagram illustrating the operation and control flow of the overall process of one embodiment of the present invention. First, a print command including a print job is received by the application 104. FIG. 4 shows that the optimal printer setting group 108 for the print job is stored in the configuration file 110 (in either an INI file 212 or a registry 214 via the custom interface 202 or the printer driver interface 204, respectively, as described in FIG. 2 above). When a print command is received by the application 104, the application 104 determines which optimal printer setting group 108 defined previously corresponds to the print job of the print command received. Then, the optimal printer setting group 108 corresponding to the print job of the print command is identified. Next, the application 104 reads the identified optimal printer setting group 108 stored in the configuration file 110.

Subsequently, the identified optimal printer setting group 108 for the print command is sent to the printer 106 by application 104. In one embodiment of the present invention, the identified optimal printer setting group 108 for the print command is sent to the printer 106 by application 104 in Print Job Language (PJL) format 402. PJL is an industry standard language for communication of information with printers. PJL includes commands for changing printer settings of a printer. In another embodiment of the present invention, the identified optimal printer setting group 108 for the print command is sent to the printer 106 by application 104 in a DEVMODE structure 404. DEVMODE is described in greater detail above.

Finally, the application 104 sends the print job to the printer 106. In one embodiment, the application 104 sends the print job to the printer 106 in a TIFF file format 406. In another embodiment, the application 104 sends the print job to the printer 106 in a native Microsoft Windows operating system file format, such as the BMP file format or the EMF file format. Next, the printer 106 proceeds to process the received print job using the received printer setting group 108. This process can be accomplished in a variety of ways.

In one embodiment, the printer settings of the printer 106 are changed to print to file. That is, so that the printer 106 prints to a file instead of the physical printer. This step allows for the adjustment of the printer settings of printer 106 for the current print job only. Once the current print job is completed, the printer settings of printer 106 are returned to their original state. Then, the print job (the TIFF file 406) is printed to a file using, for example, Kodak Imaging Control. Kodak Imaging Control is a standard imaging package available with the Microsoft Windows 2000 operating system. Then, the printer settings of printer 106 are adjusted to the optimal printer setting group 108. Next, the printer 106 is adjusted to print to a printer, instead of printing to a file. Finally, the print job is sent to the printer 106 for printing.

In another embodiment, the application 104 gains access to the printer settings of printer 106 using the Dynamic Linked Library (DLL) of the printer driver of printer 106. Then, two jobs are created and placed on the queue of the printer 106, consisting of 1) a first job for changing the settings of the printer 106 and 2) a second job for printing the desired document. The first job consists of PJL commands for changing the printer settings of the printer 106 to the optimal printer setting group 108. Finally, the document is sent to the printer 106 for printing. Subsequently, once the current print jobs are completed, the printer settings of printer 106 are returned to their original state. In one alternative to this embodiment, the application 104 converts the TIFF image 406 to a native Microsoft Windows operating system file format, such as the BMP file format or the EMF file format. BMP and EMF files are typically of a smaller size and provide better quality than a TIFF file.

In yet another embodiment, the application 104 gains access to the printer settings of printer 106 using the Dynamic Linked Library (DLL) of the printer driver of printer 106. Then, the printer settings of the printer 106 are modified using PJL commands. Subsequently, the print job (the TIFF file 406) is printed using, for example, Kodak Imaging Control. This step allows for the adjustment of the printer settings of printer 106 for the current print job only. Once the current print job is completed, the printer settings of printer 106 are returned to their original state.

FIG. 6 is an illustration of an example printer 602 with a control panel 606 and a tray 604. The printer 602 is an example of the printer 106 of FIG. 1. FIG. 6 shows that printer 602 includes a tray 604 in which media is placed for printing. FIG. 6 also shows that printer 602 includes a control panel 606 for setting printer settings. The control panel 606 includes a small screen and a set of buttons that allow for navigation and adjustment of printer settings of the printer 602.

As explained above, the control panel 606 typically allows a user to set a variety of printer settings. However, there are some printer settings that are not available for adjustment through a print dialog or GUI but that are available through the physical control panel 606 of a printer 602. Those printer settings of a printer setting group 108 that are available through the physical control panel of a printer include print speed, toner density and heat setting (fuser temperature).

### III. Exemplary Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

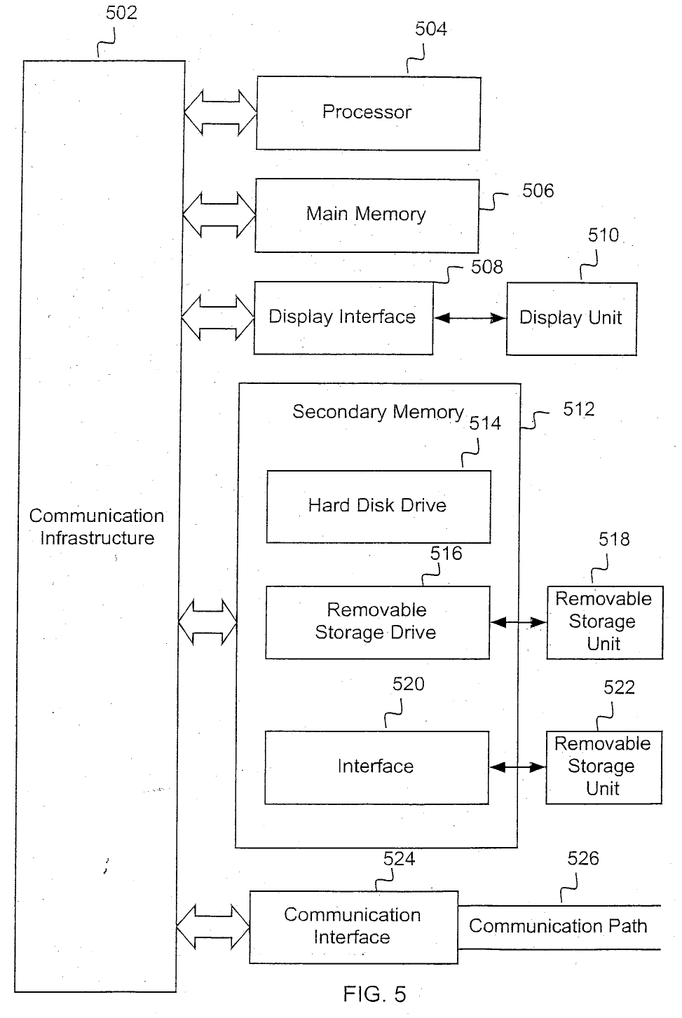

FIG. 5 is a block diagram of a computer system useful for implementing an embodiment of the present invention. The computer system includes one or more processors, such as processor 504. The processor 504 is connected to a communication infrastructure 502 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 508 that forwards graphics, text, and other data from the communication infrastructure 502 (or from a frame buffer not shown) for display on the display unit 510. The computer system also includes a main memory 506, preferably random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. Removable storage unit 518, represents a floppy disk, magnetic tape, optical disk, etc. which is read by and written to by removable storage drive 516. As will be appreciated, the removable storage unit 518 includes a computer usable storage medium having stored therein computer software and/or data.

In alternative embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system.

The computer system may also include a communications interface 524. Communications interface 524 allows software and data to be transferred between the computer system and external devices. Examples of communications interface 524 may include a modem, a network interface (such as an Ethernet card), a communications port, a PCMCIA slot and card, etc. Software and data transferred via communications interface 524 are in the form of signals which may be, for example, electronic, electromagnetic, optical, or other signals capable of being received by communications interface 524. These signals are provided to communications interface 524 via a communications path (i.e., channel) 526. This channel 526 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 506 and secondary memory 512, removable storage drive 516, a hard disk installed in hard disk drive 514, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 506 and/or secondary memory 512. Computer programs may also be received via communications interface 524. Such computer programs, when executed, enable the computer system to perform the features of the present invention as discussed herein. In particular, the computer programs, when executed, enable the processor 504 to perform the features of the computer system. Accordingly, such computer programs represent controllers of the computer system.

### IV. Conclusion

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method on an information processing system for adjusting printer settings, the method comprising:
receiving a print command for a print job;
searching a configuration file for a printer setting group corresponding to a print job;
identifying a first printer setting group as corresponding to the print job;
reading from the configuration file the first printer setting group for the first type of print job;
sending the first printer setting group to a printer; and
sending the print job of the print command to the printer.

2. The method of claim 1, wherein the first printer setting group includes at least one of the following printer settings that cannot be adjusted through the information processing system:
print speed;
toner density; and
heat setting.

3. The method of claim 2, wherein the first type of print job is associated with a type of substrate to be printed.

4. The method of claim 2, further comprising:
defining a first printer setting group for the first type of print job;
storing in a configuration file the first printer setting group for the first type of print job.

5. The method of claim 4, wherein the storing in a configuration file includes storing in the INI file the first printer setting group for the first type of print job.

6. The method of claim 5, wherein the reading from the configuration file includes reading from the INI file the first printer setting group for the first type of print job.

7. The method of claim 4, wherein the defining a first printer setting includes defining, by a user via an interface to at least one of a INI file and a registry, a first printer setting group for a first type of print job.

8. The method of claim 7, wherein the storing in a configuration file includes storing in the registry in DEVMODE format the first printer setting group for the first type of print job.

9. The method of claim 8, wherein the reading from the configuration file includes reading from the registry the first printer setting group for the first type of print job.

10. The method of claim 2, wherein the sending the first printer setting includes sending the first printer setting group to the printer in one of a PCL language and a PJL language.

11. The method of claim 2, wherein the first sending the first printer setting includes sending the first printer setting group to the printer using a printer DEVMODE structure.

12. The method of claim 2, wherein the step of sending the configuration files includes:
reading current printer settings; and
storing the current printer settings.

13. The method of claim 12, further comprising:
sending the current printer settings that were stored to the printer.

14. The method of claim 13, wherein the method is performed on a computer system executing the Windows 95/98/2000/ME/CE/NT/XP operating system.

15. A computer readable medium on an information processing system including computer instructions for adjusting printer settings, the computer instructions including instructions for:
searching a configuration file for a printer setting group corresponding to the print job;
identifying a first printer setting group as corresponding to a print job;
reading from the configuration file the first printer setting group for the first type of print job;
sending the first printer setting group to a printer; and
sending the print job of the print command to the printer.

16. The computer readable medium of claim 15, wherein the first printer setting group includes at least one of the following printer settings that cannot be adjusted through the information processing system:
print speed;
toner density; and
heat setting.

17. The computer readable medium of claim 16, wherein the first type of print job is associated with a type of substrate to be printed.

18. The computer readable medium of claim 15, further comprising computer instructions for:
reading current printer settings before sending the print job to the printer; and
storing the current printer settings.

19. The computer readable medium of claim 18, further comprising computer instructions for:
sending the current printer settings that were stored to the printer.

20. The computer readable medium of claim 19, wherein the computer instructions execute on a computer system using the Windows 95/98/2000/ME/CE/NT/XP operating system.

21. An information processing system for adjusting printer settings, comprising:
a first printer setting group for a first type of print job;
a configuration file for storing the first printer setting group for the first type of print job;
a print command for a print job;
a processor for searching the configuration file for a printer setting group corresponding to the print job according to the type of the print job, identifying the first printer setting group as corresponding to the print job, reading from the configuration file the first printer setting group for the first type of print job and sending the first printer setting group and the print job to a printer.
